(19) United States
(12) Patent Application Publication
(10) Pub. No.: US 2026/0194049 A1
(43) Pub. Date: Jul. 9, 2026

(54) SERIES ELASTIC ACTUATOR

(71) Applicants: Hyundai Motor Company, Seoul (KR); Kia Corporation, Seoul (KR); HYUNDAI WIA Corporation, Changwon-si (KR)

(72) Inventors: Woo Keun Park, Hwaseong-si (KR); Youngil Sohn, Hwaseong-si (KR); Sehyun Chang, Hwaseong-si (KR); Youn Seok Jeong, Uiwang-si (KR); Hee Joon Kim, Uiwang-si (KR); Su Min Shin, Uiwang-si (KR)

(21) Appl. No.: 19/265,110

(22) Filed: Jul. 10, 2025

(30) Foreign Application Priority Data
Jan. 9, 2025 (KR) 10-2025-0003548

(51) Int. Cl. F03G 7/00; B60G 17/015; B60G 17/018; B60G 17/02; F16F 15/121; F16D 3/62

(52) U.S. Cl. CPC F03G 7/008; B60G 17/0157; B60G 17/018; B60G 17/025; F16F 15/121; F16D 3/62

(57) ABSTRACT

A series elastic actuator can include an elastic body, a motor configured to control a deformation amount of the elastic body, and a reducer connected to the elastic body and the motor in a configuration to output an elastic force due to deformation of the elastic body to an outside. The elastic body can be located around the reducer so as to be concentrically aligned with the reducer.

### CROSS-REFERENCE TO RELATED APPLICATIONS

This application claims, under 35 U.S.C. §119(a), the benefit of priority from Korean Patent Application No. 10-2025-0003548, filed on January 9, 2025, the entire contents of which are incorporated herein by reference.

### TECHNICAL FIELD

The present disclosure relates to a series elastic actuator.

### BACKGROUND

In general, a vehicle active suspension is a device configured to actively change the characteristics of a suspension supporting a vehicle body in an electronically controlled manner.

Because a conventional active suspension requires an expensive torque sensor for torque control, the torque sensor is additionally mounted on the conventional active suspension, leading to an increase in the overall size of the active suspension.

Therefore, to stably perform torque control in a mechanical manner, research and development has been actively conducted on a series elastic actuator (SEA) configured to enable torque control by only measuring the rotation angle of an elastic body.

However, in a conventional series elastic actuator, designing an elastic body capable of generating torque (that is, elastic force) that is high enough to be applied to a vehicle active suspension is difficult. As a result, it is not possible to apply the conventional series elastic actuator to the vehicle active suspension.

The conventional series elastic actuator may not be applied to the active suspension due to the following reasons.

First, because it is required to provide a reducer having a high reduction ratio so as to implement high torque required for application to an active suspension, there is a problem in that the overall size of the conventional series elastic actuator increases due to the reducer having a high reduction ratio.

Second, to accurately measure displacement of an elastic body, an encoder connection structure needs to be provided so as to secure precise measurement performance in response to external force radially acting on the series elastic actuator. However, there is difficulty in designing such an encoder connection structure.

Third, there is difficulty in designing a series elastic actuator configured to stably implement high torque of an elastic body.

The above information disclosed in this Background section is for enhancement of understanding of the background of the present disclosure, and therefore it may contain information that does not form the prior art that is already publicly known, available, or in use.

### SUMMARY

The present disclosure relates to a series elastic actuator formed to have a compact structure and configured to stably generate high torque.

An embodiment of the present disclosure can provide a series elastic actuator formed to have a compact structure and configured to stably generate high torque.

In an embodiment of the present disclosure, a series elastic actuator can include: an elastic body; a motor configured to control a deformation amount of the elastic body; and a reducer connected to the elastic body and the motor so as to output elastic force due to deformation of the elastic body to an outside, wherein the elastic body is located around the reducer so as to be concentrically aligned with the reducer.

In an embodiment, the elastic body may include a fixed part disposed in a housing, the fixed part being coupled to a cover of the housing, a rotary part disposed in the housing, the rotary part being connected to the reducer, and a plurality of connecting bars connected to the fixed part and the rotary part, the connecting bars being arranged in a circumferential direction of the housing.

In an embodiment, each of the connecting bars may include a first end and a second end, the first end being fixed to the fixed part, the second end being assembled with the rotary part so as to be movable in an axial direction.

In an embodiment, the rotary part may have a plurality of insertion holes formed therein, the insertion holes being configured for bushes to be respectively pressed and fitted thereinto, and the connecting bars may respectively include second ends axially movably inserted into the respective bushes pressed and fitted into the respective insertion holes.

In an embodiment, the reducer may include a wave generator coupled to a motor shaft configured to output rotational force of the motor, a circular spline member coupled to the wave generator and the elastic body, the circular spline member being configured to apply the rotational force of the motor to the elastic body, a flex spline member coupled to the circular spline member and the wave generator, and an output part connected to the flex spline member and an external load, the output part being configured to output, when rotation of the motor shaft stops, the elastic force due to the deformation of the elastic body to the external load.

In an embodiment, the output part may be connected to the flex spline member through a flex connector, the rotary part of the elastic body may include a restricting rib configured to maintain concentricity between the rotary part and the flex connector, wherein the restricting rib may be located adjacent to the flex connector through a flex bearing.

In an embodiment, the circular spline member may be coupled to the rotary part of the elastic body through a first circular bracket, and the first circular bracket may be rotatably connected to the housing through a circular bearing.

In an embodiment, the series elastic actuator may further include an encoder module connected to the rotary part of the elastic body through the circular spline member, the encoder module being configured to detect the deformation amount of the elastic body.

In an embodiment, the encoder module may include an elastic member connected to the circular spline member, an encoder magnet mounted on any one of the elastic member and a mount bracket connected to the housing, and an encoder reader mounted on the other of the mount bracket and the elastic member, the encoder reader being configured to calculate the deformation amount of the elastic body based on relative displacement of the encoder magnet.

In an embodiment, the elastic member may be connected to the circular spline member through a circular cover, the circular cover may have a protrusion formed thereon and configured to maintain concentricity between the circular cover and the elastic member, and the elastic member may be coupled to the circular cover in a state of being fitted into an outer circumferential surface of the protrusion.

In an embodiment, the circular cover may have a guide rib formed thereon, the guide rib being located adjacent to an outer circumferential surface of the circular spline member.

In an embodiment, the series elastic actuator may further include a controller configured to determine, based on the deformation amount of the elastic body, torque applied to the external load through the output part, wherein the controller may be configured to stop rotation of the motor when the torque applied to the external load reaches a set, selected, or predetermined torque value.

In an embodiment, the series elastic actuator may further include a brake module configured to selectively lock driving of the motor.

In an embodiment, the brake module may include a brake member coupled to the cover of the housing and a stator of the motor, and a brake connector coupled to the motor shaft, wherein the brake member selectively restricts rotation of the brake connector.

Other aspects and embodiments of the disclosure are discussed herein. It is understood that various ones of the embodiments can be used in combination.

It can be understood that the terms "vehicle", "vehicular", and other similar terms as used herein can be inclusive of motor vehicles in general, such as passenger automobiles including sport utility vehicles (SUVs), buses, trucks, tractors, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum), for example. As referred to herein, a hybrid vehicle can be a vehicle that has two or more sources of power, for example, vehicles powered by both gasoline and electricity.

### BRIEF DESCRIPTION OF THE DRAWINGS

The above and other features of example embodiments of the present disclosure will now be described in detail with reference to the accompanying drawings, which are given by way of illustration, and thus are not necessarily limitative of the present disclosure, and wherein:

FIG. 1 is an external perspective view of a series elastic actuator according to an embodiment of the present disclosure;

FIG. 2 is a cutaway perspective view of a series elastic actuator according to an embodiment of the present disclosure;

FIGS. 3 and 4 are partially exploded perspective views of a series elastic actuator according to an embodiment of the present disclosure;

FIG. 5 is a schematic showing a connection relationship between main components of a series elastic actuator according to an embodiment of the present disclosure;

FIG. 6 is a schematic showing a control method of a series elastic actuator according to an embodiment of the present disclosure;

FIG. 7 is a perspective view of an assembled elastic body of a series elastic actuator according to an embodiment of the present disclosure;

FIG. 8 is a side view of an assembled elastic body according to an embodiment of the present disclosure; and

FIG. 9 is a partially exploded perspective view of an assembled elastic body according to an embodiment of the present disclosure.

It can be understood that the appended drawings are not necessarily to scale, can be presenting a somewhat simplified representation of various features illustrative of some principles of the present disclosure. The specific design features of an example embodiment of the present disclosure as disclosed herein, including, for example, specific dimensions, orientations, locations, and shapes can be determined in part by the particular intended application and use environment.

In the figures, reference numbers can refer to same or equivalent parts of example embodiments of the present disclosure throughout the several figures of the drawing.

### DETAILED DESCRIPTION OF ILLUSTRATIVE EMBODIMENTS

Hereinafter, reference will be made in detail to various example embodiments of the present disclosure, which are illustrated in the accompanying drawings and described below. The matters represented in the accompanying drawings are schematically illustrated to easily explain the example embodiments of the present disclosure, and may be different from actually implemented forms.

In the present disclosure, terms such as "first" and/or "second" may be used to describe various components, but the components are not necessarily limited by such terms. Such terms can be used merely for the purpose of distinguishing one component from other components. For example, a first component may be referred to as a second component, and similarly, a second component may also be referred to as a first component without departing from the scopes of rights of the present disclosure.

Unless otherwise stated herein, the radial direction and the circumferential direction can be based on a housing of a series elastic actuator, and the axial direction can be based on a motor shaft arranged in the housing.

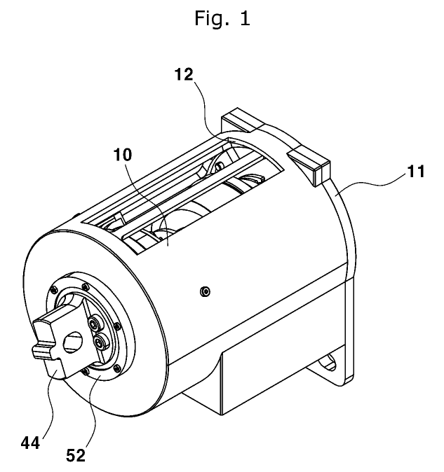

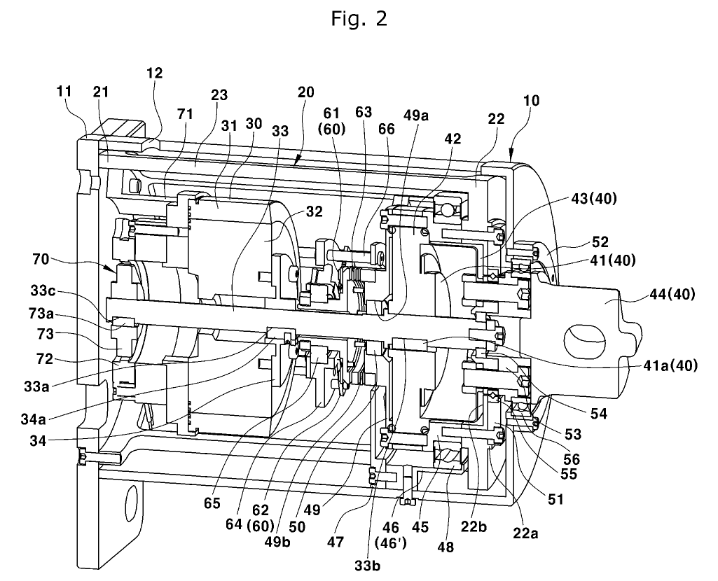

As shown in FIGS. 1 and 2, a series elastic actuator (SEA) according to an embodiment of the present disclosure can include a housing 10. The series elastic actuator can include an elastic body 20, a motor 30, a reducer 40, an encoder module 60, and an electronic brake module 70 that can be arranged in the housing 10.

The housing 10 can be formed to have a cylindrical structure in which one end in the axial direction of the housing can be open, and a cover (that is, a housing cover) 11 can be coupled to the open end. The housing 10 can have an opening 12 formed in one side in the circumferential direction thereof.

The elastic body 20 can be formed of a material having a certain, selected, or predetermined elasticity. The elastic body 20 can be disposed in the housing 10 in a state of being coupled to the housing cover 11. The elastic body 20 can be formed of a fixed part 21, a rotary part 22, and a plurality of connecting bars 23. The fixed part 21, the rotary part 22, and the plurality of connecting bars 23 may be formed to be integrated with each other.

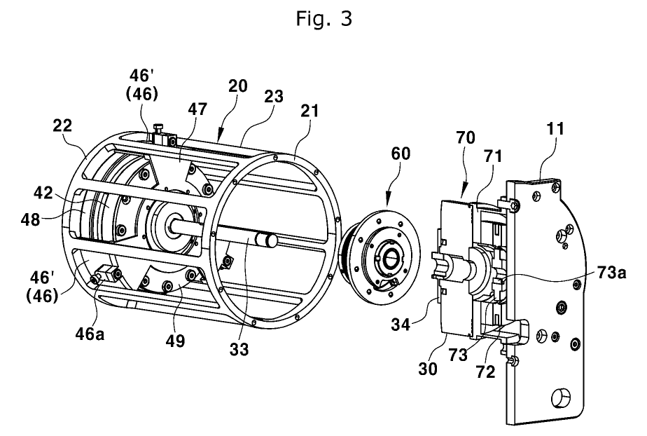

As shown in FIGS. 2 and 3, the fixed part 21 can be formed to have a ring shape and can be stacked on and coupled to the housing cover 11. The rotary part 22 can be formed to have a circular plate structure in which a central portion in the radial direction of the rotary part can be open. The rotary part 22 can be connected to the reducer 40. Each of the connecting bars 23 can extend in the axial direction of the housing 10 and connect the fixed part 21 to the rotary part 22. The connecting bars 23 can be spaced apart from each other in the circumferential direction of the housing 10. A first end of each of the connecting bars 23 can be formed to be integrated with the fixed part 21, and a second end of each of the connecting bar 23 can be formed to be integrated with the rotary part 22.

The elastic body 20 can be deformed by rotational force (that is, output torque) of the motor 30. Elastic force (that is, reaction force) due to deformation of the elastic body 20 can be output to the outside through an output part 44 of the reducer 40. In other words, reaction force generated by deformation of the elastic body 20 can be applied to an external load connected to the output part 44 of the reducer 40.

The motor 30 can be configured to generate and output torque for determining and controlling the deformation amount of the elastic body 20. A brushless direct current motor (BLDC motor) capable of performing precise output control may be used as the motor. The motor 30 can be mounted on the housing cover 11 through a brake holder 71.

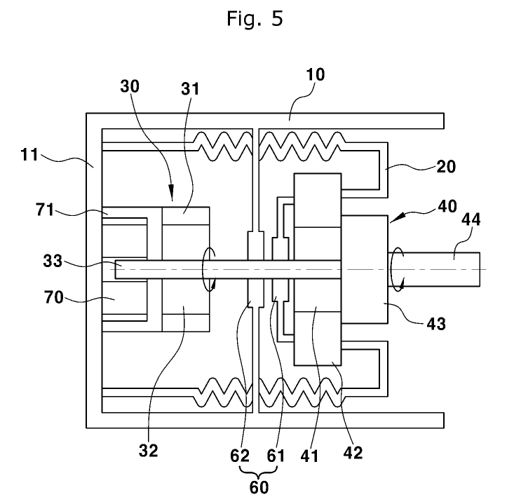

As shown in FIG. 5, the motor 30 can include a stator 31, a rotor 32, and a motor shaft 33. The motor shaft 33 can be configured to transmit output torque generated during rotation of the rotor 32 to the reducer 40. As shown in FIG. 2, the motor shaft 33 can be connected and fixed to the rotor 32 via a rotor connector 34. The rotor connector 34 can be coupled to the rotor 32 so as to be rotated integrally with the rotor.

The rotor connector 34 can be stacked on and coupled to the rotor 32 and include a first shaft key 34a inserted into a first key groove 33a of the motor shaft 33. The rotor connector 34 can be coupled to the motor shaft 33 through the first shaft key 34a and can be rotated integrally with the motor shaft 33. The first key groove 33a can be formed to be recessed in the outer circumferential surface of the motor shaft 33.

The reducer 40 can be configured to be connected to the elastic body 20 and the motor 30 and to transmit elastic force generated by deformation of the elastic body 20 to an external load. The reducer 40 can be disposed between the elastic body 20 and the motor 30 and apply output torque of the motor 30 to the elastic body 20.

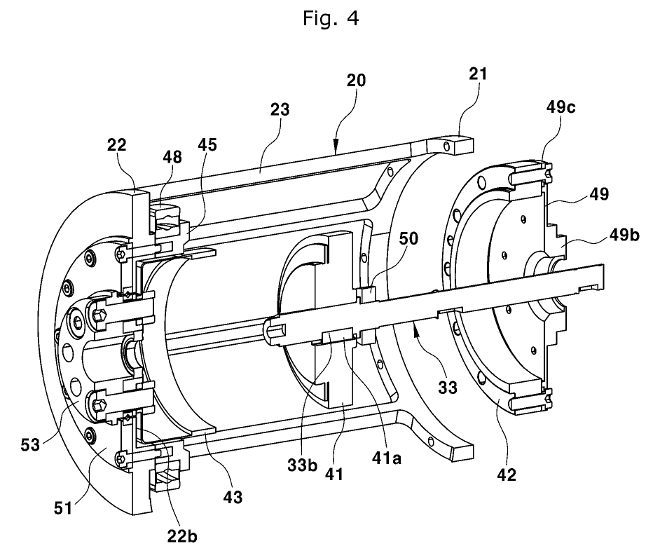

As shown in FIGS. 2 and 4, the reducer 40 can be configured to include a wave generator 41, a circular spline member 42, and a flex spline member 43.

The wave generator 41 can be coupled to the motor shaft 33 through a second shaft key 41a and can be rotated integrally with the motor shaft 33. The second shaft key 41a can be formed to protrude toward the inner circumferential surface of the wave generator 41. A second key groove 33b can be formed in the outer circumferential surface of the motor shaft 33, and the second shaft key 41a can be inserted into the second key groove 33b. The second key groove 33b can be disposed to be spaced apart from the first key groove 33a by a set distance in the axial direction.

The circular spline member 42 can be coupled to the outer circumferential surface of the wave generator 41 so as to be rotated integrally with the wave generator. The circular spline member 42 can be coupled to the wave generator 41 through the flex spline member 43. The axial end of the flex spline member 43 can be inserted into a space between the circular spline member 42 and the wave generator 41. A spline can be formed on each of the inner circumferential surface of the circular spline member 42 and the outer circumferential surface of the wave generator 41 so as to be coupled to the flex spline member 43.

The circular spline member 42 can be connected to the rotary part 22 of the elastic body 20 so as to transmit output torque of the motor 30. The circular spline member 42 can be connected and fixed to the rotary part 22 of the elastic body 20 through a first circular bracket 45 and can be connected and fixed to the housing 10 through a second circular bracket 46.

A circular bearing 48 can be mounted between the outer circumferential surface of the first circular bracket 45 and the inner circumferential surface of the second circular bracket 46. That is, the first circular bracket 45 can be rotatably connected to the housing 10 through the circular bearing 48.

The second circular bracket 46 can be directly connected to the housing 10. The second circular bracket 46 can be coupled to a third circular bracket 47 configured for the encoder module 60 to be mounted thereon.

The second circular bracket 46 can be disposed on the inside of the connecting bars 23 of the elastic body 20 with respect to the radial direction of the housing 10. The second circular bracket 46 may be formed to have a cylindrical structure or may be formed of a plurality of bracket members 46' arranged in the circumferential direction, as shown in FIG. 3. Further, each of the bracket members 46' may have a mounting boss 46a formed to protrude toward the housing 10, thereby enabling the bracket members 46' to be coupled to the housing 10 in a state of being arranged on the inside of the connecting bars 23.

As shown in FIG. 2, a circular cover 49 can be disposed between the third circular bracket 47 and the circular spline member 42. The circular cover 49 can be directly coupled to the circular spline member 42. The circular cover 49 can have an opening hole 49a configured for the motor shaft 33 to pass through a radially central portion thereof. An oil seal 50 can be inserted into and mounted in the opening hole 49a. The oil seal 50 can be in close contact with the outer circumferential surface of the motor shaft 33 and prevent leakage of a solid lubricant. The solid lubricant can be applied in advance to a connection portion between the wave generator 41, the circular spline member 42, and the flex spline member 43.

As shown in FIG. 4, the circular cover 49 can have a guide rib 49c. The guide rib 49c can extend to protrude in the axial direction from the edge of the circular cover 49. The circular spline member 42 can be located on the inner side of the guide rib 49c when combined with the circular cover 49. The guide rib 49c can be located adjacent to and can be in close contact with the outer circumferential surface of the circular spline member 42. When the circular spline member 42 and the circular cover 49 are combined, the guide rib 49c can be located adjacent to the circular spline member 42, thereby enabling the circular spline member 42 and the circular cover 49 to be concentrically aligned with each other.

The rotary part 22 of the elastic body 20 can be stacked between the first circular bracket 45 and a first bearing cover 51. The first bearing cover 51 can be fixedly coupled to the rotary part 22 and the first circular bracket 45.

The flex spline member 43 can be formed to have a cylindrical structure in which one axial side of the flex spline member is open. The flex spline member 43 can have spline structures respectively provided on the outer circumferential surface and the inner circumferential surface thereof and configured to be respectively coupled to the wave generator 41 and the circular spline member 42.

More specifically, the flex spline member 43 can have, in the axial direction thereof, a first end configured for the wave generator 41 to be inserted thereinto and coupled thereto, and a second end configured for a flex connector 53 to be coupled thereto. The first end of the flex spline member 43 can be inserted into and coupled to the inner side of the circular spline member 42.

The flex connector 53 can rotatably supports the end of the motor shaft 33 through a shaft bearing 54. The shaft bearing 54 can be mounted between the inner circumferential surface of the flex connector 53 and the outer circumferential surface of the motor shaft 33.

A flex bearing 55 can be mounted between the flex connector 53 and the first bearing cover 51. The flex bearing 55 can be coupled to the outer circumferential surface of the flex connector 53 and the inner circumferential surface of the first bearing cover 51.

The flex connector 53 can be coupled to the output part 44 connected to an external load. The output part 44 can be disposed on the outer side of the housing 10 and can be rotatably supported through an output part bearing 56. The output part bearing 56 can be stacked on one surface of the housing 10 and can be mounted between a second bearing cover 52 and the output part 44. The second bearing cover 52 can be coupled to one surface of the housing 10. The output part 44 can be rotatably supported by one surface of the housing 10 through the output part bearing 56.

The output part 44 can output, to the external load, reaction force due to deformation of the elastic body 20 when rotation of the motor shaft 33 and the wave generator 41 stops. The motor shaft 33 may be stopped by a controller 80.

The elastic body 20 can be located around the reducer 40 so as to be concentrically aligned with the reducer 40. The rotary part 22 of the elastic body 20 can be coupled to the circular spline member 42 of the reducer 40 so as to maintain a concentric state between the elastic body and the reducer. The connecting bars 23 of the elastic body 20 can be radially arranged on the outer side of the reducer 40 in a state of being spaced apart from each other in the circumferential direction.

To maintain concentricity between the elastic body 20 and the reducer 40, the rotary part 22 can be provided with a restricting rib 22a configured to prevent movement of the first bearing cover 51. As shown in FIG. 2, the restricting rib 22a can be formed to axially protrude from one surface of the rotary part 22.

The restricting rib 22a can be located adjacent to the flex connector 53 through the first bearing cover 51 and the flex bearing 55 and can maintain concentricity between the rotary part 22 and the flex connector 53.

The restricting rib 22a can be located adjacent to the outer circumferential surface of the first bearing cover 51 stacked on and coupled to one surface of the rotary part 22 so as to prevent movement of the first bearing cover 51, thereby making it possible to reduce generation of noise and vibration when the series elastic actuator is driven.

To insert the second end of the flex spline member 43 into the rotary part, a recessed groove 22b can be formed in the other surface of the rotary part 22. The second end of the flex spline member 43 can be inserted into the recessed groove 22b.

The encoder module 60 can be coupled to the third circular bracket 47 through a mount bracket 64 and can be disposed around the motor shaft 33. The mount bracket 64 can be fixedly coupled to the third circular bracket 47 through a plurality of encoder supports 66. The encoder module 60 can include an encoder magnet 61, an encoder reader 62, and an elastic member 63.

The encoder magnet 61 can be coupled to the circular spline member 42 and can be rotated in response to deformation of the elastic body 20 connected to the circular spline member 42, thereby generating corresponding rotational displacement. The encoder magnet 61 can be coupled to the circular spline member 42 through the elastic member 63 and the circular cover 49.

The circular cover 49 can have a protrusion 49b formed thereon and configured to maintain concentricity between the circular cover 49 and the elastic member 63. The elastic member 63 can be coupled to the circular cover 49 in a state of being fitted into the outer circumferential surface of the protrusion 49b. The encoder magnet 61 can be coupled to the elastic member 63 so as to face the protrusion 49b. The encoder magnet 61 can be disposed horizontally with the circular cover 49 and can be concentrically aligned with the motor shaft 33.

The elastic member 63 can be coupled to the mount bracket 64 through an encoder bearing 65. The encoder bearing 65 can be mounted between the elastic member 63 and the mount bracket 64 and rotatably support the elastic member 63.

The encoder reader 62 can be mounted on and fixed to the mount bracket 64 so as to face the encoder magnet 61. The encoder reader 62 can be configured to detect rotational displacement of the encoder magnet 61 and to calculate a deformation amount of the elastic body 20 based on the detected rotational displacement. The deformation amount of the elastic body 20 may represent the rotation angle of the rotary part 22 that is rotated with the circular spline member 42.

The encoder reader 62 can measure the displacement of the encoder magnet 61 when driving of the motor 30 is stopped and reaction force due to deformation of the elastic body 20 is output to the external load through the output part 44 of the reducer 40. When reaction force of the elastic body 20 is generated, the circular spline member 42 can be rotated with the rotary part 22 of the elastic body 20. Torsional deformation of the connecting bars 23 of the elastic body 20 can occur, and displacement of the elastic member 63 coupled to the circular spline member 42 also can occur.

Because the encoder module 60 can include the elastic member 63, eccentricity and declination due to external force input through the output part 44 of the reducer 40 do not necessarily occur. As a result, the deformation amount of the elastic body 20 may be stably measured. That is, the encoder module 60 may prevent, through the elastic member 63 provided therein, a measurement error caused by the external force input to the output part 44 of the reducer 40.

Although not shown in the drawing, the encoder magnet 61 may be mounted on the mount bracket 64 instead of the elastic member 63, and the encoder reader 62 may be mounted on the elastic member 63 instead of the mount bracket 64. The encoder reader 62 may detect relative displacement of the encoder magnet 61 and may calculate the deformation amount of the elastic body 20 based on the relative displacement.

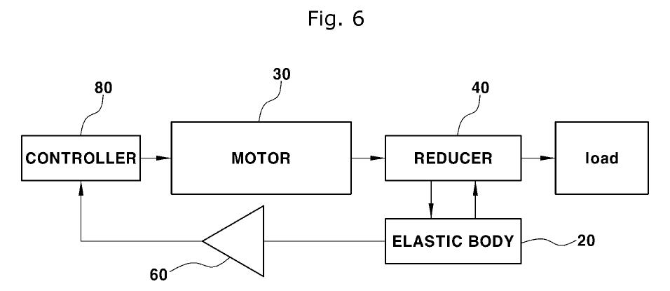

Referring to FIG. 6, a controller 80 can be configured to estimate and determine torque applied to the output part 44 of the reducer 40 (that is, output torque of the output part) based on the real-time deformation amount of the elastic body 20 measured through the encoder module 60. The controller 80 can be configured to control the feedback of the output torque of the motor 30 based on the real-time deformation of the elastic body 20. The output part 44 of the reducer 40 can apply reaction force of the elastic body 20 to an external load. The controller 80 may be one of the controllers mounted in a vehicle equipped with the series elastic actuator of an embodiment of the present disclosure.

The controller 80 can be configured to stop driving of the motor 30 when output torque of the output part 44 reaches a set, selected, or predetermined torque value. That is, the controller 80 can stop driving and rotation of the motor 30 to stop rotation of the motor shaft 33 and the wave generator 41 when the torque applied to the external load through the output part 44 reaches the set, selected, or predetermined torque value.

The brake module 70 can be configured to selectively restrict rotation of the motor shaft 33 so as to lock the motor 30. As shown in FIG. 2, the brake module 70 can include a brake member 72 mounted on the brake holder 71 and a brake connector 73 including a brake key 73a. The brake key 73a can be inserted into a third key groove 33c of the motor shaft 33. The brake holder 71 can be fixed to the housing cover 11, and the stator 31 of the motor 30 can be coupled to the brake holder 71.

When a set, selected, or predetermined voltage is applied to the brake member 72, the brake member 72 can restrain and restrict rotation of the brake connector 73, thereby locking rotation of the motor shaft 33 and driving of the motor 30.

After torque applied to the external load through the output part 44 of the reducer 40 reaches the set, selected, or predetermined torque value, the torque applied to the external load through the output part 44 may be maintained by locking rotation of the motor shaft 33 through the brake module 70.

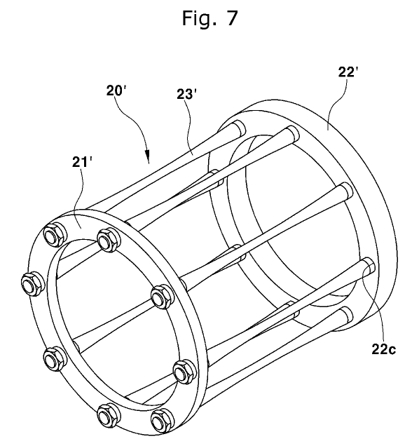

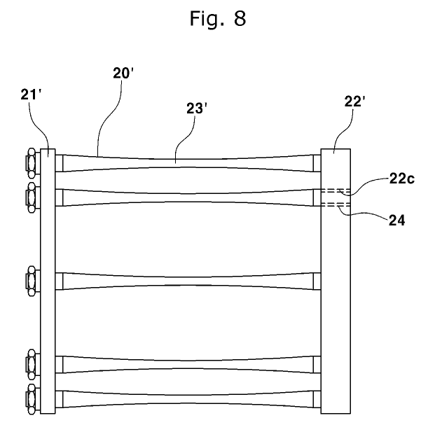

According to an embodiment shown in FIGS. 7 and 8, an elastic body 20' of an embodiment of the present disclosure may be formed to have a structure in which a fixed part 21', a rotary part 22', and connecting bars 23' can be assembled to improve mass productivity and manufacturability of the elastic body. That is, the connecting bars 23' may be detachably assembled with the fixed part 21' and the rotary part 22'.

The fixed part 21' can be fixedly coupled to the housing cover 11. The rotary part 22' can be coupled and fixed to the circular spline member 42 of the reducer 40. Each of the fixed part 21' and the rotary part 22' may be formed to have an approximately ring shape.

The rotary part 22' can be rotated by receiving output torque of the motor 30 through the circular spline member 42. When the output torque of the motor 30 is applied to the rotary part 22', the rotary part 22' can be rotated in the rotational direction of the motor 30 with the circular spline member 42.

The connecting bars 23' can be connected to the fixed part 21' and the rotary part 22'. Each of the connecting bars 23' can have a first end coupled to the fixed part 21' and a second end assembled with the rotary part 22'. Each of the connecting bars 23' can extend in the axial direction of the motor 30. The connecting bars 23' can be disposed spaced apart from each other in the circumferential direction of the motor 30.

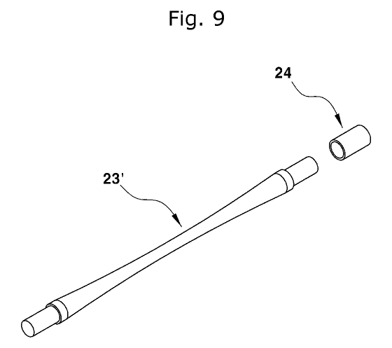

To generate axial displacement, the second end of each of the connecting bars 23' can be assembled with the rotary part 22' so as to be movable in the axial direction. The rotary part 22' can have a plurality of insertion holes 22c formed therein, and the second ends of the connecting bars 23' can be respectively assembled with the insertion holes 22c so as to be movable in the axial direction through respective cylindrical bushes 24. The first end of each of the connecting bars 23' may be fixed to the fixed part 21' through bolting, and the second end of each of the connecting bars 23' may be inserted into and connected to a corresponding one of the bushes 24. Each of the bushes 24 may be fixed to the rotary part 22' by being pressed into a corresponding one of the insertion holes 22c of the rotary part 22'. As shown in FIGS. 8 and 9, each of the connecting bars 23' may be formed to be tapered toward a central portion in the axial direction thereof.

The series elastic actuator of an embodiment of the present disclosure may be configured to have a structure including any one of the integral elastic body 20 shown in FIG. 3 or the assembled elastic body 20' shown in FIG. 7. The assembled elastic body 20', each of the rotary part 22' and the fixed part 21' may be formed of a non-elastic material, and each of the connecting bars 23' may be formed of an elastic material, for example.

Because the assembled elastic body 20' can include the bushes 24, the assembled elastic body may respond to axial movement that occurs when relatively high torque is applied thereto from the motor 30.

Although not shown in the drawing, the rotary part 22' of the assembled elastic body 20' may be formed to have the same disk structure as the rotary part 22 of the integral elastic body 20 or a disk structure similar thereto.

When the series elastic actuator according to an embodiment of the present disclosure is applied to a vehicle suspension, the output part 44 of the reducer 40 may be connected to a suspension upper arm, for example.

As can be apparent from the above description, an embodiment of the present disclosure provides the following effects and advantages.

First, an elastic body and a reducer can be mounted in a housing in a state being concentrically aligned with each other, thereby having an advantage of reducing the overall size of a series elastic actuator.

Second, an encoder module can be formed of an elastic member. Accordingly, even if external force is radially applied to the encoder module, it can be possible not only to secure precise measurement performance, but also to stably measure the deformation amount of the elastic body.

Third, when an assembled elastic body is applied to the series elastic actuator, axial displacement may occur, and the assembled elastic body may respond to axial movement that occurs when relatively high torque is applied thereto.

The advantages of an embodiment of the present disclosure are not necessarily limited to the above-mentioned advantages, and other advantages not mentioned herein can be understood by those skilled in the art from the detailed description of the example embodiments of the present disclosure.

The example embodiments of the present disclosure have been described in detail above, and terms or words used in this specification and claims can be construed as being not necessarily limited to typical or dictionary meanings. Because the example embodiments described in this specification and the configurations shown in the drawings are example implementations, the scopes of the present disclosure are not necessarily limited to the above-described example embodiments. A number of embodiments have been disclosed herein. It can be understood that various features of the different embodiments can be combined. Various modifications and improvements made by those skilled in the art using concepts of the present disclosure defined in the following claims, and equivalents thereof, can also fall within the scopes of the present disclosure.

What is claimed is:

1. A series elastic actuator comprising:
an elastic body;
a motor configured to control a deformation amount of the elastic body; and
a reducer connected to the elastic body and the motor in a configuration to output an elastic force due to deformation of the elastic body to an outside, wherein the elastic body is located around the reducer to be concentrically aligned with the reducer.

2. The series elastic actuator of claim 1, further comprising a housing, and wherein the elastic body comprises:
a fixed part disposed in the housing, the fixed part being coupled to a cover of the housing;
a rotary part disposed in the housing, the rotary part being connected to the reducer; and
a plurality of connecting bars connected to the fixed part and the rotary part, the connecting bars being arranged in a circumferential direction of the housing.

3. The series elastic actuator of claim 2, wherein each of the connecting bars comprises a first end and a second end, the first end being fixed to the fixed part, the second end being assembled with the rotary part to be movable in an axial direction.

4. The series elastic actuator of claim 2, further comprising bushes, wherein the rotary part has a plurality of insertion holes formed in the rotary part, the insertion holes being configured for the bushes to be respectively press fitted into the insertion holes, and
wherein the connecting bars respectively comprise second ends axially movably inserted into the bushes, respectively.

5. The series elastic actuator of claim 2, further comprising a motor shaft coupled to the motor, and wherein the reducer comprises:
a wave generator coupled to the motor shaft configured to output a rotational force of the motor;
a circular spline member coupled to the wave generator and the elastic body, the circular spline member being configured to apply the rotational force of the motor to the elastic body;
a flex spline member coupled to the circular spline member and the wave generator; and
an output part connected to the flex spline member, the output part being configured to output, based on rotation of the motor shaft being stopped, the elastic force due to the deformation of the elastic body to an external load.

6. The series elastic actuator of claim 5, further comprising a flex connector, wherein the output part is connected to the flex spline member through the flex connector, and
wherein the rotary part of the elastic body comprises a restricting rib configured to maintain concentricity between the rotary part and the flex connector, wherein the restricting rib is located adjacent to the flex connector through a flex bearing.

7. The series elastic actuator of claim 5, further comprising:
a first circular bracket, wherein the circular spline member is coupled to the rotary part of the elastic body through the first circular bracket; and
a circular bearing, wherein the first circular bracket is rotatably connected to the housing through the circular bearing.

8. The series elastic actuator of claim 5, further comprising an encoder device connected to the rotary part of the elastic body through the circular spline member, the encoder device being configured to detect the deformation amount of the elastic body.

9. The series elastic actuator of claim 8, wherein the encoder device comprises:
an elastic member connected to the circular spline member;
an encoder magnet mounted on any one of the elastic member and a mount bracket connected to the housing; and
an encoder reader mounted on another of the mount bracket and the elastic member, the encoder reader being configured to determine the deformation amount of the elastic body based on relative displacement of the encoder magnet.

10. The series elastic actuator of claim 9, further comprising a circular cover, wherein the elastic member is connected to the circular spline member through the circular cover,
wherein the circular cover has a protrusion formed on the circular cover and configured to maintain concentricity between the circular cover and the elastic member, and
wherein the elastic member is coupled to an outer circumferential surface of the protrusion.

11. The series elastic actuator of claim 10, wherein the circular cover includes a guide rib formed on the circular cover, the guide rib being located adjacent to an outer circumferential surface of the circular spline member.

12. The series elastic actuator of claim 5, further comprising a controller configured to determine, based on the deformation amount of the elastic body, torque applied to the external load through the output part,
wherein the controller is configured to stop rotation of the motor based on determining that the torque applied to the external load reaches a first torque value.

13. The series elastic actuator of claim 5, further comprising a brake device configured to selectively lock driving of the motor.

14. The series elastic actuator of claim 13, wherein the brake device comprises:
a brake member coupled to the cover of the housing and a stator of the motor; and
a brake connector coupled to the motor shaft, wherein the brake member is configured to selectively restrict rotation of the brake connector.
